(19) United States
(12) Patent Application Publication
(10) Pub. No.: US 2006/0119324 A1
(43) Pub. Date: Jun. 8, 2006

(54) Electronic equipment system and control method thereof

(76) Inventor: Sung-hun Kim, Suwon-si (KR)

Correspondence Address: STANZIONE & KIM, LLP, 919 18TH STREET, N.W., SUITE 440, WASHINGTON, DC, 20006, US

(21) Appl. No.: 11/288,391

(22) Filed: Nov. 29, 2005

(30) Foreign Application Priority Data
Dec. 3, 2004 (KR) 2004-101430

(51) Int. Cl. H02J 7/00

(52) U.S. Cl. 320/150

(57) ABSTRACT

An electronic equipment system includes a battery to supply a pre-stored electric power, a temperature detector to detect a temperature of the battery, a power supply to receive the electric power from the battery and to supply a system electric power, and a controller to control the power supply so that the electronic equipment system is operated in a power saving mode when it is determined that the temperature of the battery is beyond a predetermined temperature based on the detection of the temperature detector. Thus, a running time of the battery is prolonged, a life span of a battery is extended through a full discharge, and a loss of data being processed by sudden shut down of the electronic equipment system is prevented.

### CROSS-REFERENCE TO RELATED APPLICATIONS

This application claims the benefit of Korean Patent Application No. 2004-0101430, filed on Dec. 3, 2004 in the Korean Intellectual Property Office, the disclosure of which is incorporated herein by reference in its entirety.

### BACKGROUND OF THE INVENTION

1. Field of the Invention

The present general inventive concept relates to an electronic equipment system and a control method thereof, and more particularly, to an electronic equipment system that extends a life span of the system using a battery by inducing full discharge of the battery, and to prevent data being processed from being lost by a sudden shut down of the system, and a method of controlling the same.

2. Description of the Related Art

Generally, a portable electronic equipment system employs a battery from which electric power is provided. A temperature of the battery rises to a maximum level while the battery is discharged. The more discharge current there is, the greater a rising rate of the temperature. The battery is typically a smart battery.

The electric power consumed by the electronic equipment system increases because of various contents and supplementary functions. However, an increased rate of a capacity of the electric power of the smart battery does not meet rapidly rising consumption of electric power of the electronic equipment.

Thus, in order to prevent the temperature of the battery from rising too high, a conventional portable electronic equipment system uses a thermal protection function that stops the battery from discharging if a battery temperature rises over a predetermined limitation temperature.

Hereinbelow, the thermal protection function will be described with reference to FIG. 1.

A conventional smart battery of the portable electronic equipment system comprises a temperature detector detecting a temperature of the smart battery, and the smart battery provides driving electric power to the system. As illustrated in FIG. 1, the temperature of the smart battery ‘c’ rises gradually, while a remaining smart battery electric power decreases gradually when the battery is discharged. Here, ‘b’ is a discharge current of the smart battery. The conventional smart battery continues to operate by discharging a regular amount of current up until a point when the temperature reaches a predetermined limitation temperature (e.g., 55 degrees C.). The conventional smart battery then stops discharging the current (i.e., shuts down the portable electronic equipment system). Thus, the flow of the discharge current is blocked off even though a remaining electric power ‘a’ is stored in the smart battery.

However, in the conventional portable electronic equipment system, when the temperature of the conventional smart battery is higher than the predetermined limitation temperature, the smart battery stops discharging by itself using the thermal protection function, so that a user may be confused by the stopping of the conventional portable electronic equipment system and data being processed may be lost. Further, since there is the remaining smart battery electric power ‘a’ at a time t1 when the smart battery stops discharging, a running time of the electronic equipment system is shortened, and a life span of the conventional smart battery is shortened because the smart battery is not completely discharged.

### SUMMARY OF THE INVENTION

The present general inventive concept provides an electronic equipment system and a control method thereof, in which a running time of a battery is prolonged, a life span of a battery is not shortened through a full discharge, and a loss of data being processed by sudden shut down of the electronic equipment system is prevented.

Additional aspects of the present general inventive concept will be set forth in part in the description which follows and, in part, will be obvious from the description, or may be learned by practice of the general inventive concept.

The foregoing and/or other aspects of the present general inventive concept may be achieved by providing an electronic equipment system, comprising a battery to supply a pre-stored electric power, a temperature detector to detect a temperature of the battery, a power supply to receive the electric power from the battery and to supply a system electric power, and a controller to control the power supply so that the electronic equipment system is operated in a power saving mode when it is determined that the temperature of the battery is beyond a predetermined temperature based on the detection of the temperature detector.

The temperature detector may be provided in the battery, and the battery may comprise a smart battery that includes a power storage to store the electric power and a battery microcomputer to output a temperature detection signal of the temperature detector to the controller.

The battery microcomputer may output a predetermined alert signal to the controller when it is determined that the temperature of the battery is beyond the predetermined temperature based on the detection of the temperature detector, and the controller controls the power supply so that the electronic equipment system is operated in the power saving mode when the controller receives the predetermined alert signal from the battery microcomputer.

The electronic equipment system may further comprise an indicator to indicate an operation state of the electronic equipment system, wherein the controller controls the indicator to indicate the temperature of the battery when the temperature of the battery is beyond the predetermined temperature.

The indicator may include one or more of a sound output part to output a predetermined alert sound and an image output part to display a predetermined alert message.

The battery may comprise a switching circuit to switch on/off the electric power transmitted from the power storage to the power supply, and the battery microcomputer controls the switching circuit to cut off the electric power supplied to the power supply when it is determined that the temperature of the battery is beyond a predetermined limitation temperature that is higher than the predetermined temperature based on the detection of the temperature detector.

The electronic equipment system may further comprise a switching circuit to switch on/off the electric power transferred from the battery to the power supply, wherein the controller controls the switching circuit to cut off the electric power supplied to the power supply, when it is determined that the temperature of the battery is beyond a predetermined limitation temperature that is higher than the predetermined temperature based on the detection of the temperature detector.

The foregoing and/or other aspects of the present general inventive concept may also be achieved by providing a portable electronic equipment system, comprising a data processing unit to process data, a battery to supply power to the data processing unit, and a controller to control the supply of power from the battery to the data processing unit to operate in one of a first power supply mode, a second power supply mode, and a third power supply mode according to a temperature of the battery.

The foregoing and/or other aspects of the present general inventive concept may also be achieved by providing a power supply controller usable with a portable electronic equipment system, the controller comprising a control unit to regulate current that is discharged from a system battery to the portable electronic equipment system, to enable a first amount of current to be discharged from the system battery when a temperature of the system battery is below a predetermined temperature, and to enable a second amount of current when to be discharged by the system battery when the temperature of the system battery is above the predetermined temperature.

The foregoing and/or other aspects of the present general inventive concept may also be achieved by providing a smart battery usable with a portable electronic equipment system, comprising a power storage to store power, a temperature detector to detect a temperature of the power storage, a battery controller to cut off power supplied from the power storage when the detected temperature of the smart battery is greater than a predetermined temperature limit, and a power supply regulator to regulate a discharge current output from the smart battery according to the detected temperature of the smart battery when the power supplied by the power storage is not cut off.

The foregoing and/or other aspects of the present general inventive concept may also be achieved by providing a control method of an electronic equipment system having a battery to supply an electric power, and a power supply to receive the electric power from the battery and to supply a system electric power, the method comprising determining whether a temperature of the battery is beyond a predetermined temperature, and controlling the power supply so that the electronic equipment system is operated in a power saving mode, when it is determined that the temperature of the battery is beyond the predetermined temperature. The method may further comprise indicating the temperature of the battery when the temperature of the battery is beyond the predetermined temperature.

The indicating of the temperature of the battery may comprise outputting a predetermined alert sound based on the temperature of the battery.

The indicating of the temperature of the battery may comprise displaying a predetermined alert message based on the temperature of the battery.

The method may further comprise cutting off the electric power supplied to the power supply when it is determined that the temperature of the battery is beyond a predetermined limitation temperature that is higher than the predetermined temperature while the electronic equipment system operates in the power saving mode.

The foregoing and/or other aspects of the present general inventive concept may also be achieved by providing a method of controlling a portable electronic equipment system, the method comprising supplying power from a battery to a data processing unit to process data, and controlling the supply of power from the battery to the data processing unit to operate in one of a first power supply mode, a second power supply mode, and a third power supply mode according to a temperature of the battery.

The foregoing and/or other aspects of the present general inventive concept may also be achieved by providing a method of controlling power in a portable electronic equipment system, the method comprising storing power in a power storage of a smart battery, detecting a temperature of the smart battery, cutting off power supplied from the power storage when the detected temperature of the smart battery is greater than a predetermined temperature limit, and regulating a discharge current output from the smart battery according to the detected temperature of the smart battery when the power supplied is not cut off.

The foregoing and/or other aspects of the present general inventive concept may also be achieved by providing a computer readable medium containing executable code to control a power supply in a portable electronic equipment system, the medium comprising an executable code to regulate current that is discharged from a system battery to the portable electronic equipment system by enabling a first amount of current to be discharged from the system battery when a temperature of the system battery is below a predetermined temperature, and enabling a second amount of current to be discharged from the system battery when the temperature of the system battery is above the predetermined temperature.

### BRIEF DESCRIPTION OF THE DRAWINGS

The above and/or other aspects of the present general inventive concept will become apparent and more readily appreciated from the following description of the embodiments, taken in conjunction with the accompanying drawings of which:

FIG. 1 illustrates a rise in temperature of a battery when the battery discharges current in a conventional electronic equipment system;

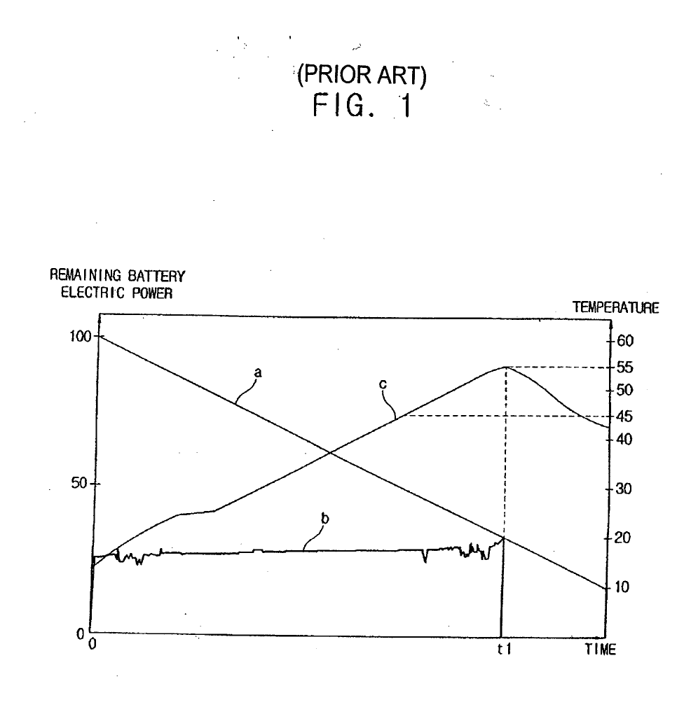

FIG. 2 is a block diagram illustrating an electronic equipment system according to an embodiment of the present general inventive concept;

FIG. 3 is a control block diagram illustrating an electronic equipment system according to another embodiment of the present general inventive concept;

FIG. 4 is a control flowchart illustrating a control method of an electronic equipment system according to an embodiment the present general inventive concept; and

FIG. 5 illustrates a rise in temperature of a battery when a battery discharges in an electronic equipment system according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

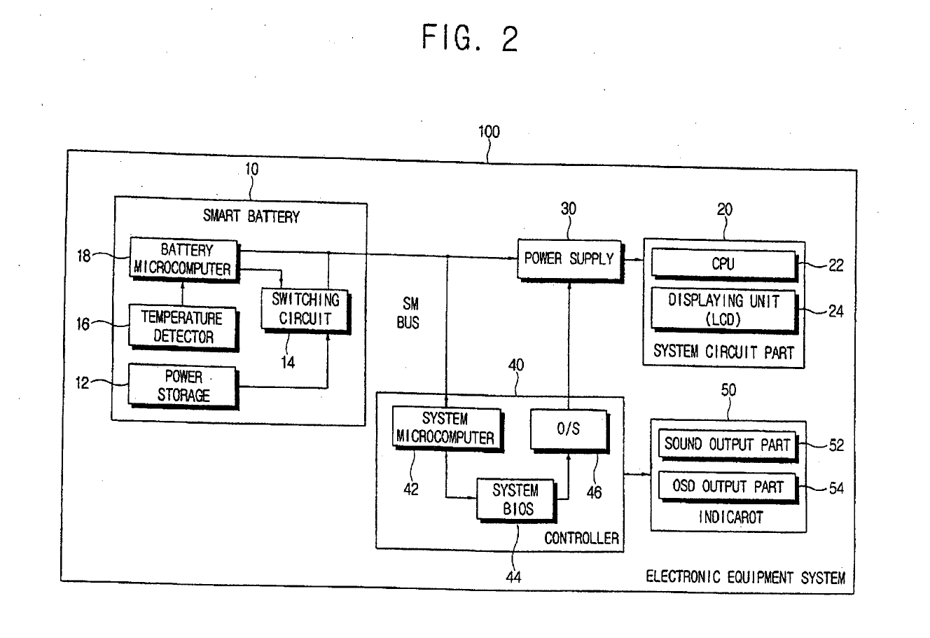

FIG. 2 is a block diagram illustrating an electronic equipment system 100 according to an embodiment of the present general inventive concept. The electronic equipment system 100 comprises a smart battery 10 that provides a pre-stored electric power, a power supply 30 that receives electric power from the smart battery 10 and supplies system electric power, a system circuit part 20 comprising a CPU 22, a displaying unit 24 or the like, and a controller 40 to control the power supply 30 so that the electronic equipment system 100 may be operated in a power saving mode when it is determined that a temperature of the smart battery 10 is beyond a predetermined temperature and in a normal mode when the temperature of the smart battery 10 is not beyond the predetermined temperature.

The smart battery 10 comprises a power storage 12 to store the electric power, a temperature detector 16 to detect a temperature of the power storage 12, a switching circuit 14 to switch on/off the electric power supplied from the power storage 12 to the power supply 30 or to adjust a level of the electric power to a first level and a second level, a battery microcomputer 18 to output a temperature detection signal of the temperature detector 16 to the controller 40 and to control the switching circuit 14 to cut off or adjust the electric power supplied to the power supply 30 when it is determined that the temperature of the power storage 12 is beyond a predetermined limitation temperature based on the temperature detected by the temperature detector 16.

Here, the battery microcomputer 18 may continuously provide the controller 40 with the temperature detection signal of the temperature detector 16. However, the battery microcomputer 18 may alternatively output a predetermined alert signal to the controller 40 when the temperature of the power storage 12 is beyond the predetermined temperature based on the temperature detected by the temperature detector 16.

Here, the smart battery 10 may charge and discharge. Further, the battery microcomputer 18 and the controller 40 may communicate with each other through an I2C bus or an SM (system management) bus.

The power supply 30 receives the electric power from the smart battery 10, and provides the system circuit part 20 with system electric power so that the system may be operated in an operation mode according to the control of the controller 40 (to be described later).

The controller 40 controls the power supply 30 so that the electronic equipment system 100 may be operated in the power saving mode, if it is determined that the temperature of the smart battery 10 is beyond the predetermined temperature by the temperature detection signal received from the battery microcomputer 18.

The controller 40 may include a system microcomputer 42 to output a control signal, if it is determined that the temperature of the smart battery 10 is beyond the predetermined temperature while receiving the temperature detection signal continuously (or periodically) from the battery microcomputer 18 and to detect the temperature of the smart battery 10, a system bios 44 to transmit a control signal received from the system microcomputer 42 to an O/S 46, and the O/S 46 to control the power supply 30 so that the electronic equipment system 100 may be operated in the power saving mode according to the control signal received from the system bios 44.

Here, the system microcomputer 42 receives the temperature detection signal from the battery microcomputer 18 continuously, periodically, or to indicate that the temperature of the smart battery 10 is beyond the predetermined temperature. However, when the system microcomputer 42 receives the predetermined alert signal that indicates that the temperature of the power storage 12 is beyond the predetermined temperature from the battery microcomputer 18, the system microcomputer 42 may output a control signal based on the predetermined alert signal.

Generally, the power saving mode may be an operation mode that changes a software/hardware operating state of a system and reduces electric power consumption. Various methods are possible to realize the power saving mode. For example, the power saving mode may control electric power supplied from the power supply 30 to the system circuit part 20 and may turn off an unnecessary function part or lower a frequency of the CPU 22 and brightness of an LCD in the displaying unit 24.

Here, the battery microcomputer 18 may control the switching circuit 14 so as to cut off the electric power supplied from the power storage 12 to the power supply 30 when it is determined that the temperature of the power storage 12 is beyond the predetermined limitation temperature, which is higher than the predetermined temperature.

Thus, when the temperature of the smart battery 10 is beyond the predetermined limitation temperature, the battery microcomputer 18 secures the electronic equipment system 100 by cutting off the supplied electric power.

Further, the electronic equipment system 100 according to the present embodiment may further include an indicator 50 to indicate an operation state of the electronic equipment system 100. The controller 40 may control the indicator 50 to indicate the temperature of the smart battery 10 when it is determined that the temperature of the smart battery 10 is beyond the predetermined temperature by the temperature detection signal received from the battery microcomputer 18.

The indicator 50 may include either a sound output part 52 to output a predetermined beep sound or a predetermined alert voice, and/or an OSD output part 54 to display a predetermined OSD alert message on the displaying unit 24. The indicator 50 may be formed with an LED (not shown).

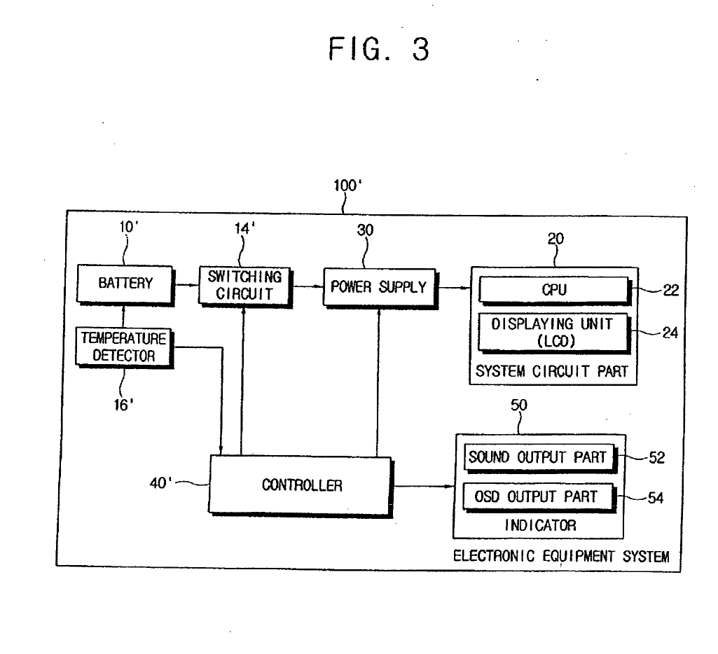

FIG. 3 illustrates an electronic equipment system 100′ according to another embodiment of the present general inventive concept. It should be understood that some of the components of the electronic equipment system 100′ are the same as components of the electronic equipment system 100, and are labeled accordingly in FIG. 3.

Referring to FIGS. 2 and 3, the electronic equipment system 100′ comprises a battery 10′ to provide pre-stored electric power, the power supply 30 to supply a system electric power received from the battery 10′, a switching circuit 14′ to switch on/off an electric power supplied from the power supply 30, the system circuit part 20 (same as FIG. 2) comprising the CPU 22, the displaying unit 24 or the like, a temperature detector 16′ to detect a temperature of the battery 10′, and a controller 40′ to control the power supply 30 so that the electronic equipment system 100 may be operated in a power saving mode when it is determined that the temperature of the battery 10′ is beyond a predetermined temperature.

In the present embodiment, the battery 10′ does not communicate with the controller 40′ in the electronic equipment system 100′ as compared with the smart battery 10 in the electronic equipment system 100, and may charge and discharge manually.

The power supply 30 receives the electric power from the battery 10′, and supplies the system electric power to the system circuit part 20 so that the electronic equipment system 100′ may be operated in an operation mode according to the control of the controller 40′ (to be described below)

The controller 40′ controls the power supply 30 so that the electronic equipment system 100′ may be operated in the power saving mode, when it is determined that the temperature of the battery 10′ is beyond the predetermined temperature based on a result detected by the temperature detector 16′.

Further, the controller 40′ controls the switching circuit 14′ to cut off the electric power transmitted from the battery 10′ to the power supply 30, when it is determined that the temperature of the battery 10′ is beyond a predetermined limitation temperature which is higher than the predetermined temperature.

Thus, when the temperature of the battery 10′ is beyond the predetermined limitation temperature, the controller 40′ secures the electronic equipment system 100′ by cutting off the electric power.

Here, the power saving mode can be realized in a manner described above with reference to the electronic equipment system 100.

Further, the electronic equipment system 100′ may further comprise the indicator 50. The controller 40′ may control the indicator 50 to indicate the temperature of the battery 10′ when it is determined that the temperature of the battery 10′ is beyond the predetermined temperature.

The indicator 50 may comprise either the sound output part 52 and/or the OSD output part 54, and may be formed with the LED (not shown), as described above.

Hereinbelow, a control flow of the electronic equipment system 100, described above, will be described with reference to FIGS. 2, 4, and 5, and will be described with respect to the embodiment 100 of FIG. 2. Moreover, it should be understood that a similar control flow may be applied to the embodiment of FIG. 3.

First, the temperature detector 16 detects the temperature of the power storage 12 at operation S10. The battery microcomputer 18 determines whether the temperature of the power storage 12 is beyond the predetermined temperature (e.g., 45° C.) by the result detected by the temperature detector 16 at operation S20. The predetermined temperature may be a predetermined alert temperature.

The battery microcomputer 18 outputs an alert signal to the controller 40 when it is determined that the temperature of the power storage 12 is beyond the predetermined temperature. Thus, the controller 40 controls the indicator 50 and informs a user of the temperature of the smart battery 10 through an alert sound or an alert message at operation S30. Thus, the user can recognize that the temperature of the smart battery 10 is heated at a high temperature, realizes that the electronic equipment system 100 may shut down operation by a thermal protection function, and prevents data being processed from being lost by saving the data. Alternatively, the controller 40 may automatically save the data being processed when the alert signal is received from the battery microcomputer 18.

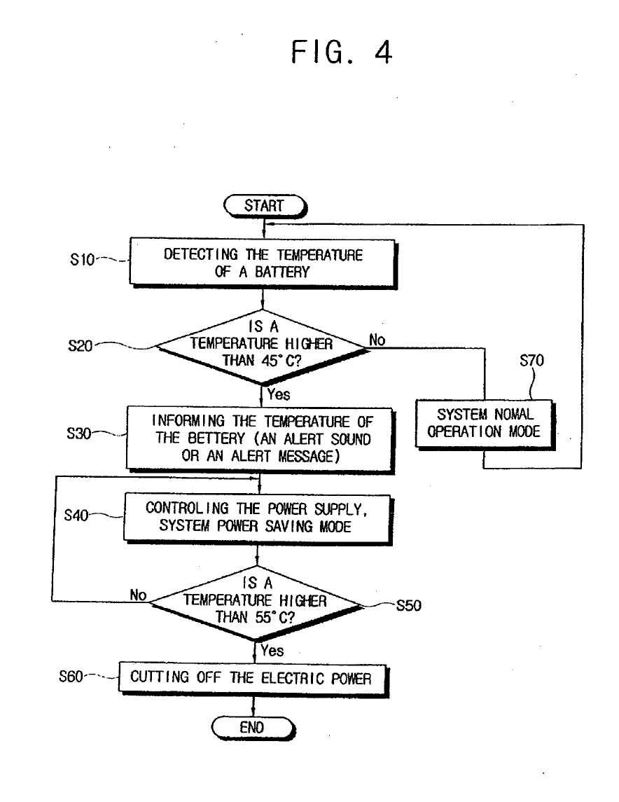

Further, the controller 40 controls the power supply 30 so that the electronic equipment system 100 may be operated in the power saving mode at operation S40. Here, the battery microcomputer 18 determines whether the temperature of the power storage 12 is beyond the predetermined limitation temperature (e.g., 55° C.) at operation S50. The battery microcomputer 18 cuts off the electric power supplied to the power supply 30 by controlling the switching circuit 14 when the battery microcomputer 18 determines that the temperature of the power storage 12 is beyond the predetermined limitation temperature at operation S60. The predetermined limitation temperature may be a predetermined cut off temperature. Although FIG. 4 illustrates that the predetermined limitation temperature is 55 degrees Celsius and the predetermined temperature is 45 degrees Celsius, it should be understood that these temperatures are exemplary and are not intended to limit the scope of the present general inventive concept. Other temperature values may also be used.

At operation S20, when the temperature of the power storage 12 is not beyond the predetermined temperature, the controller 40 controls the power supply 30 so that the electronic equipment system 100 may be operated in a normal operation mode at operation S70.

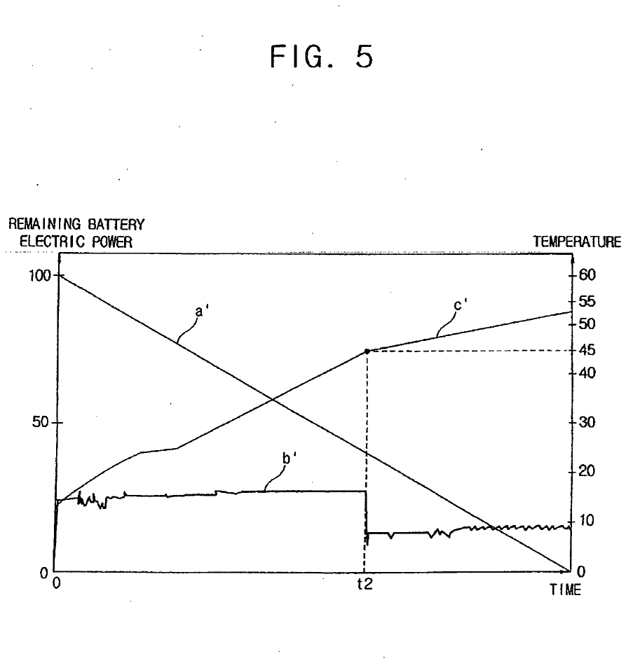

As illustrated in FIG. 5, since the system is operated in a power saving mode at a time t2 when the temperature of the smart battery 10 is beyond the predetermined temperature, an amount of a discharge current b′ of the smart battery 10 is reduced, and a temperature rising rate c′ of the smart battery 10 after the time t2 decreases. Thus a user may use the electronic equipment system 100′ for a longer period of time, and resolve the problem that the life span of the smart battery 10 is shortened, by completely discharging a remaining battery electric power a′ of the smart battery 10.

As described above, an electronic equipment system of the various embodiments of the present general inventive concept and a control method thereof, a running time of a battery in the electronic equipment system increases, a loss of the data being processed is prevented through a thermal protection function performed according to a rise of a temperature of the battery. Further, the electronic equipment system and the control method thereof decreases a temperature rising rate of the battery and induces a full discharge so that a problem of a life span shortening can be improved.

The embodiments of the present general inventive concept can be embodied as computer readable codes on a computer readable recording medium. The computer readable recording medium may include any data storage device that can store data which can be thereafter read by a computer system. Examples of the computer readable recording medium include a read-only memory (ROM), a random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. The embodiments of the present general inventive concept may also be embodied in hardware or a combination of hardware and software. For example, an embodiment of the present general inventive concept may be a computer readable medium that controls the electronic equipment system to operate in power saving mode or a normal mode.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An electronic equipment system, comprising:
a battery to supply a pre-stored electric power;
a temperature detector to detect a temperature of the battery;
a power supply to receive the electric power from the battery and to supply a system electric power; and
a controller to control the power supply so that the electronic equipment system is operated in a power saving mode when it is determined that the temperature of the battery is beyond a predetermined temperature based on the detection of the temperature detector.

2. The electronic equipment system according to claim 1, wherein the temperature detector is provided in the battery, and the battery comprises a smart battery that includes a power storage to store the electric power and a battery microcomputer to output a temperature detection signal of the temperature detector to the controller.

3. The electronic equipment system according to claim 2, wherein the battery microcomputer outputs a predetermined alert signal to the controller when it is determined that the temperature of the battery is beyond the predetermined temperature based on the detection of the temperature detector, and the controller controls the power supply so that the electronic equipment system is operated in the power saving mode when the controller receives the predetermined alert signal from the battery microcomputer.

4. The electronic equipment system according to claim 3, further comprising:
an indicator to indicate an operation state of the electronic equipment system,
wherein the controller controls the indicator to indicate the temperature of the battery when the temperature of the battery is beyond the predetermined temperature.

5. The electronic equipment system according to claim 4, wherein the indicator comprises one or more of a sound output part to output a predetermined alert sound and an image output part to display a predetermined alert message.

6. The electronic equipment system according to claim 5, wherein the battery comprises a switching circuit to switch on/off the electric power transmitted from the power storage to the power supply, and the battery microcomputer controls the switching circuit to cut off the electric power supplied to the power supply when it is determined that the temperature of the battery is beyond a predetermined limitation temperature that is higher than the predetermined temperature based on the detection of the temperature detector.

7. The electronic equipment system according to claim 1, further comprising:
an indicator to indicate an operation state of the electronic equipment system,
wherein the controller controls the indicator to indicate the temperature of the battery when the temperature of the battery is beyond the predetermined temperature.

8. The electronic equipment system according to claim 7, wherein the indicator comprises one or more of a sound output part to output a predetermined alert sound and an image output part to display a predetermined alert message.

9. The electronic equipment system according to claim 8, wherein the battery comprises:
a switching circuit to switch on/off the electric power transmitted from the power storage to the power supply; and
a microcomputer to control the switching circuit to cut off the electric power supplied to the power supply when it is determined that the temperature of the battery is beyond a predetermined limitation temperature that is higher than the predetermined temperature based on the detection of the temperature detector.

10. The electronic equipment system according to claim 1, further comprising:
a switching circuit to switch on/off the electric power transferred from the battery to the power supply,
wherein the controller controls the switching circuit to cut off the electric power supplied to the power supply, when it is determined that the temperature of the battery is beyond a predetermined limitation temperature that is higher than the predetermined temperature based on the detection of the temperature detector.

11. A portable electronic equipment system, comprising:
a data processing unit to process data;
a battery to supply power to the data processing unit; and
a controller to control the supply of power from the battery to the data processing unit to operate in one of a first power supply mode, a second power supply mode, and a third power supply mode according to a temperature of the battery.

12. The system of claim 11, further comprising:
a temperature detector to detect the temperature of the battery and to provide the temperature of the battery to the controller.

13. The system of claim 11, wherein:
the first power supply mode comprises a shut down mode to shut down operation of the system when the temperature of the battery is detected as being above a cut off temperature;
the second power supply mode comprises a power save mode to operate the system without one or more non-critical performance factors when the temperature of the battery is detected as being above an alert temperature and below the cut off temperature; and
the third power supply mode comprises a normal operation mode to operate the system normally when the temperature of the battery is detected as being below the alert temperature.

14. The system of claim 11, wherein the battery comprises a smart battery including:
a power storage to store power in the battery;
the temperature detector to detect the temperature of the battery;
a battery microcomputer to output the temperature of the battery detected by the temperature detector to the controller; and
a switching circuit to cut off the power supplied by the power storage when the detected temperature of the battery is above a cut off temperature.

15. The system of claim 11, further comprising:
a power supply to be regulated by the controller to receive the power from the battery and to be operated in the second power mode as a power saving mode when the detected temperature of the battery is above an alert temperature and to be operated in the third power mode as a full power mode when the detected temperature of the battery is below the alert temperature.

16. A power supply controller usable with a portable electronic equipment system, the controller comprising:
a control unit to regulate current that is discharged from a system battery to the portable electronic equipment system, to enable a first amount of current to be discharged from the system battery when a temperature of the system battery is below a predetermined temperature, and to enable a second amount of current to be discharged from the system battery when the temperature of the system battery is above the predetermined temperature.

17. The controller of claim 16, wherein the system battery heats up at a slower rate when the second amount of current is being discharged therefrom than when the first amount of current is discharged, and the portable electronic equipment system continues operation with the second amount of current until power stored in the system battery is expired or until the temperature of the system battery falls below the predetermined temperature.

18. A smart battery usable with a portable electronic equipment system, comprising:
a power storage to store power;
a temperature detector to detect a temperature of the power storage; and
a controller to cut off power supplied from the power storage when the detected temperature of the smart battery is greater than a predetermined temperature limit and to regulate a discharge current output from the smart battery between a first level of power and a second level of power according to the detected temperature of the smart battery when the power supplied by the power storage is not cut off.

19. The smart battery of claim 18, wherein the temperature comprises one of a first temperature, a second temperature, and a third temperature, and the controller regulates the discharge current to a first level according to the first temperature, to a second level according to the second temperature, and to a cutoff level according to the third temperature.

20. The smart battery of claim 19, wherein;
the first temperature is less than the second temperature, and the second temperature is less than the third temperature; and
the first level is greater than the second level, and the second level is greater than the cutoff level.

21. A control method of an electronic equipment system having a battery to supply an electric power, and a power supply to receive the electric power from the battery and to supply a system electric power, the method comprising:
determining whether a temperature of the battery is beyond a predetermined temperature; and
controlling the power supply so that the electronic equipment system is operated in a power saving mode, when it is determined that the temperature of the battery is beyond the predetermined temperature.

22. The method according to claim 21, further comprising:
indicating the temperature of the battery when the temperature of the battery is beyond the predetermined temperature.

23. The method according to claim 22, wherein the indicating of the temperature of the battery comprises outputting a predetermined alert sound based on the temperature of the battery.

24. The method according to claim 22, wherein the indicating of the temperature of the battery comprises displaying a predetermined alert message based on the temperature of the battery.

25. The method according to claim 21, further comprising:
cutting off the electric power supplied to the power supply when it is determined that the temperature of the battery is beyond a predetermined limitation temperature that is higher than the predetermined temperature while the electronic equipment system operates in the power saving mode.

26. A method of controlling a portable electronic equipment system, the method comprising:
supplying power from a battery to a data processing unit to process data; and
controlling the supply of power from the battery to the data processing unit to operate in one of a first power supply mode, a second power supply mode, and a third power supply mode according to a temperature of the battery.

27. The method of claim 26, further comprising:
detecting the temperature of the battery.

28. The method of claim 26, wherein the controlling of the supply of power comprises:
controlling the supply of power to operate in the first power supply mode by shutting down operation of the system when the temperature of the battery is detected as being above a cut off temperature;
controlling the supply of power to operate in the second power supply mode by operating the system in a power save mode without one or more non-critical performance factors when the temperature of the battery is detected as being above an alert temperature and below the cut off temperature; and
controlling the supply of power to operate in the third power supply mode by operating the system in a normal operation mode when the temperature of the battery is detected as being below the alert temperature.

29. The method of claim 26, wherein the supplying of the power from the battery to the data processing unit comprises:
storing power in a power storage of the battery;
detecting the temperature of the battery; and
cutting off the power supplied by the power storage when the detected temperature of the battery is above a cut off temperature.

30. The method of claim 26, further comprising:
regulating a power supply that receives the power from the battery and operating the power supply in the second power mode as a power saving mode when the detected temperature of the battery is detected to be above an alert temperature and operating the power supply in the third power mode as a full power mode when the detected temperature of the battery is below the alert temperature.

31. A method of controlling power in a portable electronic equipment system, the method comprising:
storing power in a power storage of a smart battery;
detecting a temperature of the smart battery;
cutting off power supplied from the power storage when the detected temperature of the smart battery is greater than a predetermined temperature limit; and
regulating a discharge current output from the smart battery according to the detected temperature of the smart battery when the power supplied is not cut off.

32. A computer readable medium containing executable code to control a power supply in a portable electronic equipment system, the medium comprising:
an executable code to regulate current that is discharged from a system battery to the portable electronic equipment system by enabling a first amount of current to be discharged from the system battery when a temperature of the system battery is below a predetermined temperature, and enabling a second amount of current to be discharged from the system battery when the temperature of the system battery is above the predetermined temperature.

33. The medium of claim 32, wherein the system battery heats up at a slower rate when the second amount of current is being discharged therefrom than when the first amount of current is discharged, and the portable electronic equipment system continues operation with the second amount of current until power stored in the system battery is expired or until the temperature of the system battery falls below the predetermined temperature.
